(19) United States
(12) Patent Application Publication
(10) Pub. No.: US 2026/0182669 A1
(43) Pub. Date: Jul. 2, 2026

(54) AEROSOL-GENERATING DEVICE WITH HEATING TEMPERATURE VARIATION

(71) Applicant: Philip Morris Products S.A., Neuchatel (CH)

(72) Inventors: Fabrice STEFFEN, Colombier (CH); Alexandros Vassilios VASSILIOU, Muntelier (CH)

(73) Assignee: Philip Morris Products S.A., Neuchatel (CH)

(21) Appl. No.: 19/491,622

(22) PCT Filed: Jul. 8, 2024
(86) PCT No.: PCT/EP2024/069219

§ 371 Date: Dec. 9, 2025

(30) Foreign Application Priority Data
Jul. 12, 2023 (EP) 23386060.0

(51) Int. Cl. A24F 40/57; A24F 40/20; A24F 40/465; H05B 6/06; H05B 6/10

(52) U.S. Cl. CPC A24F 40/57; A24F 40/465; H05B 6/06; H05B 6/105; A24F 40/20

(57) ABSTRACT

A method of operating an aerosol-generating device for generating an aerosol from an aerosol-forming substrate during a usage session is provided, the device including a heater, a power supply to supply power to the heater during the usage session, and control electronics; and the method including using the control electronics to: initiate one of a plurality of predetermined different heating profiles for the heater, each profile including different target operating temperatures for the heater, one profile including a temperature increase of subsequent target operating temperatures and another one profile including a temperature decrease of subsequent target operating temperatures, and control a supply of power to adjust a temperature of the heater to a target operating temperature, each of the plurality of target operating temperatures including between 4 and 7 different target operating temperatures, and the temperature of the heater increases or decreases linearly from one target to a next target.

The present invention relates to a method of operating an aerosol-generating device, a storage medium for use in an aerosol-generating device, an aerosol-generating device, as well as an aerosol-generating system.

It is known to provide an aerosol-generating device for generating an inhalable vapor. Such devices may heat aerosol-forming substrate to a temperature at which one or more components of the aerosol-forming substrate are volatilised without burning the aerosol-forming substrate. An aerosol-forming substrate may be a liquid substrate contained in a reservoir. An aerosol-forming substrate may be a solid substrate provided as part of an aerosol-generating article. The aerosol-generating article may have a rod shape for insertion of the aerosol-generating article into a cavity, such as a heating chamber, of the aerosol-generating device. A heater may be arranged in or around the heating chamber for heating the aerosol-forming substrate once the aerosol-generating article is inserted into the heating chamber of the aerosol-generating device.

Some aerosol-generating devices are configured to provide user experiences that have a finite duration. The duration of a usage session may be limited, for example, to approximate the experience of consuming a traditional cigarette. Some aerosol-generating devices are configured to be used with separate, consumable, aerosol-generating articles. Such aerosol-generating articles comprise an aerosol-forming substrate or substrates that are capable of releasing volatile compounds that can form an aerosol. Aerosol-forming substrates are commonly heated to form an aerosol. As the volatile compounds in an aerosol-forming substrate are depleted, the quality of the aerosol produced may deteriorate. Thus, some aerosol-generating devices are configured to limit the duration of the usage session to help prevent generation of a lower quality aerosol from a substantially depleted aerosol-forming substrate of an aerosol-generating article. A user would inhale aerosol from such a known aerosol-generating device by the application of one or more puffs to the device during the usage session. Some known aerosol-generating devices may limit the duration of the usage session based upon when a number of puffs applied to the device in the session reaches a predetermined limit.

It is known to provide power to a heater to heat an aerosol-forming substrate in accordance with a heating profile which varies over the duration of a usage session. In effect, such known heating profiles define a temperature variation for the heater as a function of the time elapsed in the usage session. As an aerosol-forming substrate becomes more depleted during a usage session, more energy is required to extract the remaining volatile compounds of the substrate which form the aerosol. Thus, it is known to use a heating profile which increases a target operating temperature for the heater over the second half of a usage session. Known heating profiles used in the operation of a heater can be based on an idealised, hypothetical usage session or on the puff behaviour of a user. However, these solutions may not work for all puff behaviours of a user and can then lead to an inconsistent delivery profile. In particular when a user's puff behaviour is very inconsistent.

It would be desirable to provide a method of operating an aerosol-generating device with improved aerosol generation for a variety of puff behaviours. It would be desirable to provide a method of operating an aerosol-generating device with improved aerosol generation for a high frequency puff behaviour and for a low frequency puff behaviour. It would be desirable to provide a method of operating an aerosol-generating device that provides an improved delivery profile. It would be desirable to provide a method of operating an aerosol-generating device that provides an individual heating profile.

According to an embodiment of the invention there is provided a method of operating an aerosol-generating device for generating an aerosol from an aerosol-forming substrate during a usage session. The aerosol-generating device may comprise at least one of a heater, a power supply arranged to supply power to the heater during the usage session, and control electronics. The method may comprise using the control electronics of the aerosol-generating device to initiate one of a plurality of predetermined different heating profiles for the heater. Each heating profile may comprise a plurality of different target operating temperatures for the heater. One heating profile may comprise a temperature increase of subsequent target operating temperatures and one heating profile may comprise a temperature decrease of subsequent target operating temperatures. The method may further comprise controlling the supply of power from the power supply in order to adjust a temperature of the heater to the target operating temperature.

According to an embodiment of the invention there is provided a method of operating an aerosol-generating device for generating an aerosol from an aerosol-forming substrate during a usage session. The aerosol-generating device comprises a heater, a power supply arranged to supply power to the heater during the usage session, and control electronics. The method comprises using the control electronics of the aerosol-generating device to initiate one of a plurality of predetermined different heating profiles for the heater. Each heating profile comprises a plurality of different target operating temperatures for the heater. One heating profile comprises a temperature increase of subsequent target operating temperatures and one heating profile comprises a temperature decrease of subsequent target operating temperatures. The method further comprises controlling the supply of power from the power supply in order to adjust a temperature of the heater to the target operating temperature.

By initiating one of a plurality of predetermined different heating profiles for the heater, a method of operating an aerosol-generating device may be provided with improved aerosol generation for a variety of puff behaviours. By initiating one of a plurality of predetermined different heating profiles for the heater, a method of operating an aerosol-generating device may be provided with improved aerosol generation for a high frequency puff behaviour and for a low frequency puff behaviour. By initiating one of a plurality of predetermined different heating profiles for the heater, a method of operating an aerosol-generating device may be provided that provides an improved delivery profile. By initiating one of a plurality of predetermined different heating profiles for the heater, a method of operating an aerosol-generating device may be provided that provides individual heating profiles. By initiating one of a plurality of predetermined different heating profiles comprising a plurality of different target operating temperatures, a versatile operating mode of a heater of an aerosol-generating device may be provided. By initiating one of a plurality of predetermined different heating profiles wherein one heating profile comprises a temperature increase of subsequent target operating temperatures and one heating profile comprises a temperature decrease of subsequent target operating temperatures, a versatile operating mode of a heater of an aerosol-generating device may be provided with improved aerosol generation for a high frequency puff behaviour and for a low frequency puff behaviour.

The aerosol-generating device may comprise a storage medium storing the plurality of predetermined heating profiles. The control electronics may comprise the storage medium. The storage medium may store a set of a plurality of predetermined heating profiles. The aerosol-generating device may store a plurality of sets of a plurality of predetermined heating profiles. The user may select one set of the plurality of sets of a plurality of predetermined heating profiles via a user interface of the aerosol-generating device, or via an external device such as a smartphone, tablet or a smartwatch. The aerosol-generating device may be electrically or wirelessly connectable to such an external device.

The control electronics may be electrically connected to the power supply, the heater and preferably to other controllable portions of the aerosol-generating device. The control electronics may comprise a controller.

The plurality of heating profiles may comprise at least two different heating profiles, preferably at least three different heating profiles. The plurality of heating profiles may comprise a first heating profile comprising a temperature increase of subsequent target operating temperatures and a second heating profile comprising a temperature decrease of subsequent target operating temperatures.

The plurality of heating profiles may comprise a first heating profile comprising a temperature increase of subsequent target operating temperatures, a temperature decrease of subsequent target operating temperatures and preferably a temperature plateau of subsequent target operating temperatures. A plateau of subsequent target operating temperatures may be a series of identical target operating temperatures.

The plurality of heating profiles may comprise a second and a third heating profile each comprising a temperature increase of subsequent target operating temperatures, a temperature decrease of subsequent target operating temperatures and preferably a temperature plateau of subsequent target operating temperatures.

The control electronics may be configured to measure time intervals. The control electronics may comprise a timer for measuring time intervals. A heating profile may be a series of at least two, preferably at least three, more preferably more than three target operating temperatures to which the heater is heated at specific timer intervals. Each of the plurality of different target operating temperatures for the heater may be associated to a plurality of different predetermined time intervals, respectively. A predetermined time interval may be the time elapsed from the initiation of the specific heating profile. The heater may reach the specific target operating temperature at the end of the associated time interval.

The plurality of different predetermined time intervals may comprise 2 to 10 different time intervals, preferably 3 to 8 different time intervals. The plurality of different predetermined time intervals may comprise a first, a second and a third predetermined time interval, wherein the second predetermined time interval may be longer than the first predetermined time interval and the third predetermined time interval may be longer than the second predetermined time interval. Preferably, the plurality of different predetermined time intervals may further comprise a fourth, a fifth and a sixth predetermined time interval, wherein the fourth predetermined time interval may be longer than the third predetermined time interval, the fifth predetermined time interval may be longer than the fourth predetermined time interval, and the sixth predetermined time interval may be longer than the fifth predetermined time interval.

The sum of all predetermined time intervals of a heating profile may be a total duration of a heating profile. The individual heating profiles may all have the same total durations. The plurality of predetermined heating profiles may comprise heating profiles with different total durations. A total duration of a heating profile may be between 40 to 80 seconds, preferably between 50 to 70 seconds, more preferably about 60 seconds.

The plurality of different target operating temperatures may comprise a first, a second and a third target operating temperature. The first target operating temperature may be associated to the first predetermined time interval, the second target operating temperature may be associated to the second predetermined time interval, and the third target operating temperature may be associated to the third predetermined time interval.

Preferably the plurality of different target operating temperatures may further comprise a fourth, a fifth and a sixth target operating temperature. The fourth target operating temperature may be associated to the fourth predetermined time interval, the fifth target operating temperature may be associated to the fifth predetermined time interval and the sixth target operating temperature may be associated to the sixth predetermined time interval.

The plurality of predetermined heating profiles may be between 5 to 20 different predetermined heating profiles, preferably between 8 to 15 different predetermined heating profiles, more preferably between 11 and 14 different predetermined heating profiles.

The aerosol-generating device may comprise a puff sensor configured to detect a puff by a user on the aerosol-generating device. The puff sensor may be electrically connected to the power supply and the control electronics. The puff sensor may be an airflow sensor or the like. The puff sensor may perform puff detection indirectly based upon detecting a temperature change in the heater which would be expected to accompany any applied puff. Determination of a temperature of the heater may be performed directly by use of a temperature sensor. The temperature of the heater may be determined indirectly based upon a change in one or more operating parameters of the aerosol-generating device. For example, the temperature of the heater may be determined based upon an electrical resistance of the heater; this is particularly relevant to where the heater is a resistive heater. In another example, if the heater takes the form of a susceptor which in use is heated by an inductor, the temperature of the susceptor may be determined based upon changes in the current supplied to the inductor from the power supply.

The plurality of heating profiles may be initiated in dependence of a puff count of an applied puff in the usage session. The detection of a puff may increase the puff count. The plurality of predetermined heating profiles may be initiated sequentially one after the other in dependence of the puff count. When no puff is detected during a heating profile, the puff count may be increased. The puff count may be increased after the elapse of a specific time interval. The puff count may be increased after the last of the plurality of predetermined time intervals has elapsed. When the puff count is increased, the next of the plurality of predetermined heating profiles may be initiated. Each of the plurality of predetermined heating profiles may be associated to a respective value of the puff count.

The values of the puff count may be integers including 0. The integer 0 may be set before a puff is detected. The puff count may be 1 when a first puff is detected.

The method may further comprise performing a pre-heating after a manual activation by a user. The pre-heating may comprise heating the heater to a predetermined pre-heating target temperature during a predetermined pre-heating time. During this pre-heating time the puff count may be deactivated. Preferably the pre-heating time may be 20 to 60 seconds, more preferably 25 to 35 seconds. The pre heating time may be about 28 seconds. The method may further comprise providing at least one haptic feedback by the device after one or both of the heater reaches a specific temperature, the elapse of a specific time interval, and the elapse of the pre-heating time. A first predetermined heating profile of the plurality of predetermined heating profiles may be initiated after the elapse of the pre-heating time. Preferably each of the plurality of predetermined heating profiles may be associated to a respective value of the puff count. The value 0 of the puff count may be associated to the first predetermined heating profile.

The last predetermined heating profile may be re-looped until a specific time interval has elapsed. This specific time interval may be the maximal user experience time. The maximal user experience time may be between 400 to 600 seconds.

The plurality of target operating temperatures may comprise at least two different target operating temperatures. The plurality of target operating temperatures may comprise at least three different target operating temperatures. Each of the plurality of target operating temperatures may comprise between 3 to 8 different target operating temperatures, preferably between 4 and 7 different target operating temperatures. The temperature of the heater may increase or decrease linearly from one target operating temperature to the next target operating temperature.

After initiation of a specific predetermined heating profile, the puff count may be deactivated for a predetermined blank time interval. Preferably the predetermined blank time interval may be 0 to 10 seconds, more preferably, preferably 0 to 5 seconds, most preferably 1 to 5 seconds.

The present invention further relates to a storage medium for use in an aerosol-generating device. The storage medium containing instructions for performing the method described herein on the aerosol-generating device when interacting with aerosol-forming substrate. The storage medium may store the different predetermined heating profiles. The storage medium may be provided in a controller used to control the power supply. Alternatively, the storage medium may be a discrete component separate to but accessible to such a controller. Preferably, the storage medium is both readable and writable in use, which thereby provides a benefit of enabling a thermal profile stored in the storage medium to be modified during the course of a usage session. The storage medium may be a computer-readable medium. The computer-readable medium may be a computer memory.

The present invention further relates to an aerosol-generating device for generating an aerosol from an aerosol-forming substrate during a usage session. The aerosol-generating device comprises a heater, a power supply arranged to supply power to the heater during the usage session, control electronics, and the storage medium described herein.

The present invention further relates to an aerosol-generating system comprising the aerosol-generating device described herein and an aerosol-generating article. The aerosol-generating article comprises the aerosol-forming substrate. The aerosol-generating device is configured to receive the aerosol-generating article. The aerosol-generating article may comprise the heater. The heater may comprise a susceptor element and the aerosol-generating device may comprise an inductor. The inductor may be configured controllable by the control electronics to control the temperature of the susceptor element. The aerosol-generating article and device are preferably configured such that when the article is received by the device, the inductor and susceptor are positioned relative to each other so that the provision of power from the power supply to the inductor induces eddy currents into the susceptor, thereby causing heating of the aerosol-forming substrate.

The heater of the aerosol-generating device may comprise a resistive heating element.

As used herein, the term ‘aerosol-generating device’ refers to a device that interacts with one or both of an aerosol-generating article and a cartridge to generate an aerosol.

As used herein, the term ‘aerosol-generating article’ refers to an article comprising an aerosol-forming substrate that is capable of releasing volatile compounds that can form an aerosol. For example, an aerosol-generating article may be an article that generates an aerosol that is directly inhalable by the user drawing or puffing on a mouthpiece at a proximal or user-end of the device. An aerosol-generating article may be disposable. The aerosol-generating article may be insertable into the heating chamber of the aerosol-generating device. The aerosol-generating article may comprise a substrate portion comprising aerosol-forming substate and a mouthpiece portion comprising a filter material.

As used herein, the term ‘aerosol-forming substrate’ relates to a substrate capable of releasing volatile compounds that can form an aerosol or a vapor. Such volatile compounds may be released by heating the aerosol-forming substrate. The aerosol-forming substrate may be in solid form or may be in liquid form. The terms ‘aerosol’ and ‘vapor’ are used synonymously.

As used herein, the term ‘usage session’ refers to a period in which a series of puffs are applied by a user to extract aerosol from an aerosol-forming substrate.

As used herein, the term ‘aerosol-generating system’ refers to the combination of an aerosol-generating device with one or both of a cartridge and an aerosol-generating article. In the system, the aerosol-generating device and one or both of the aerosol-generating article and the cartridge cooperate to generate a respirable aerosol.

As used herein, a ‘susceptor’ or ‘susceptor element’ means an element that heats up when subjected to an alternating magnetic field. This may be the result of eddy currents induced in the susceptor element, hysteresis losses, or both eddy currents and hysteresis losses. During use, the susceptor element is located in thermal contact or close thermal proximity with an aerosol-forming substrate received in the aerosol-generating article or cartridge. In this manner, the aerosol-forming substrate is heated by the susceptor such that an aerosol is formed.

The aerosol-forming substrate may comprise nicotine. The nicotine-containing aerosol-forming substrate may be a nicotine salt matrix.

The aerosol-forming substrate may comprise plant-based material. The aerosol-forming substrate may comprise tobacco. The aerosol-forming substrate may comprise a tobacco-containing material including volatile tobacco flavour compounds which are released from the aerosol-forming substrate upon heating. Alternatively, the aerosol-forming substrate may comprise a non-tobacco material. The aerosol-forming substrate may comprise homogenised plant-based material. The aerosol-forming substrate may comprise homogenised tobacco material. Homogenised tobacco material may be formed by agglomerating particulate tobacco.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the aerosol-generating system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as triethylene glycol, 1,3-butanediol. Preferably, the aerosol former is glycerine. Where present, the homogenised tobacco material may have an aerosol-former content of equal to or greater than 5 percent by weight on a dry weight basis, and preferably from 5 percent to 30 percent by weight on a dry weight basis. The aerosol-forming substrate may comprise other additives and ingredients, such as flavourants.

The aerosol-generating device may comprise a housing. The housing may include the user interface to activate the aerosol-generating device, for example a button to initiate heating of the aerosol-generating device or a display to indicate a state of the aerosol-generating device or of the aerosol-forming substrate.

The rechargeable power supply of one or both of the charger and the aerosol-generating device may be a direct current (DC) power supply. In one embodiment, the rechargeable power supply is a DC power supply having a DC supply voltage in the range of 2.5 Volts to 4.5 Volts and a DC supply current in the range of 1 Amp to 10 Amps (corresponding to a DC power supply in the range of 2.5 Watts to 45 Watts). The aerosol-generating device may advantageously comprise a direct current to alternating current (DC/AC) inverter for converting a DC current supplied by the DC power supply to an alternating current. The DC/AC converter may comprise a Class-D, Class-C or Class-E power amplifier. The AC power output of the DC/AC converter is supplied to the induction coil.

Below, there is provided a non-exhaustive list of non-limiting examples. Any one or more of the features of these examples may be combined with any one or more features of another example, embodiment, or aspect described herein.
Example Ex 1: A method of operating an aerosol-generating device for generating an aerosol from an aerosol-forming substrate during a usage session, the aerosol-generating device comprising:
a heater;
a power supply arranged to supply power to the heater during the usage session; and
control electronics;
the method comprises using the control electronics of the aerosol-generating device to:
initiate one of a plurality of predetermined different heating profiles for the heater, wherein each heating profile comprises a plurality of different target operating temperatures for the heater, wherein one heating profile comprises a temperature increase of subsequent target operating temperatures and one heating profile comprises a temperature decrease of subsequent target operating temperatures;
control the supply of power from the power supply in order to adjust a temperature of the heater to the target operating temperature.
Example Ex 2: The method according to example Ex 1, wherein the plurality of heating profiles comprises a first heating profile comprising a temperature increase of subsequent target operating temperatures, a temperature decrease of subsequent target operating temperatures and preferably a temperature plateau of subsequent target operating temperatures.
Example Ex 3: The method according to example Ex 2, wherein the plurality of heating profiles comprises a second and a third heating profile each comprising a temperature increase of subsequent target operating temperatures, a temperature decrease of subsequent target operating temperatures and preferably a temperature plateau of subsequent target operating temperatures.
Example Ex 4: The method according to any of the preceding examples, wherein each of the plurality of different target operating temperatures for the heater is associated to a plurality of different predetermined time intervals, respectively.
Example Ex 5: The method according to any of the preceding examples, wherein the plurality of different target operating temperatures comprises a first, a second and a third target operating temperature, wherein the first target operating temperature is associated to a first predetermined time interval, the second target operating temperature is associated to a second predetermined time interval, and the third target operating temperature is associated to a third predetermined time interval, preferably wherein the plurality of different target operating temperatures further comprises a fourth, a fifth and a sixth target operating temperature, wherein the fourth target operating temperature is associated to a fourth predetermined time interval, the fifth target operating temperature is associated to a fifth predetermined time interval and the sixth target operating temperature is associated to a sixth predetermined time interval.
Example Ex 6: The method according to any of the preceding examples, wherein the plurality of predetermined heating profiles is between 5 to 20 different predetermined heating profiles, preferably between 8 to 15 different predetermined heating profiles, more preferably between 11 and 14 different predetermined heating profiles.
Example Ex 7: The method according to any of the preceding examples, wherein the aerosol-generating device comprises a puff sensor configured to detect a puff by a user on the aerosol-generating device.
Example Ex 8: The method according to example Ex 7, wherein each of the plurality of heating profiles is initiated in dependence of a puff count of an applied puff in the usage session.
Example Ex 9: The method according to any of examples Ex 7 or Ex 8, wherein detection of a puff increases the puff count.
Example Ex 10: The method according to any of examples Ex 7 or Ex 9, wherein the plurality of predetermined heating profiles is initiated sequentially one after the other in dependence of the puff count.
Example Ex 11: The method according to any of any of examples Ex 7 to Ex 10, wherein, when no puff is detected during a heating profile, the puff count is increased.
Example Ex 12: The method according to any of examples Ex 7 to Ex 11, wherein, when the puff count is increased, the next of the plurality of predetermined heating profiles is initiated.
Example Ex 13: The method according to any of examples Ex 7 to Ex 12, wherein each of the plurality of predetermined heating profiles is associated to a respective value of the puff count.
Example Ex 14: The method according to any of examples Ex 7 to Ex 13, wherein the values of the puff count can be integers including 0, wherein the integer 0 is set before a puff is detected, wherein the puff count is 1 when a first puff is detected.
Example Ex 15: The method according to any of examples to any of examples Ex 7 to Ex 14, further comprising performing a pre-heating after a manual activation by a user, wherein the pre-heating comprises heating the heater to a predetermined pre-heating target temperature during a predetermined pre-heating time, wherein during this pre-heating time the puff count is deactivated, preferably wherein the pre-heating time is 20 to 60 seconds, more preferably 25 to 35 seconds.
Example Ex 16: The method according to example Ex 15, further comprising providing at least one haptic feedback by the device after one or both of the heater reaches a specific temperature, the elapse of a specific time interval, and the elapse of the pre-heating time.
Example Ex 17: The method according to any of examples Ex 15 or Ex 16, wherein a first predetermined heating profile of the plurality of predetermined heating profiles is initiated after the elapse of the pre-heating time, preferably wherein each of the plurality of predetermined heating profiles is associated to a respective value of the puff count, and wherein the value 0 of the puff count is associated to the first predetermined heating profile.
Example Ex 18: The method according to any of the preceding examples, wherein each of the plurality of target operating temperatures comprises between 3 to 8 different target operating temperatures, preferably between 4 and 7 different target operating temperatures.
Example Ex 19: The method according to any of example Ex 18, wherein the temperature of the heater increases or decreases linearly from one target operating temperature to the next target operating temperature.
Example Ex 20: The method according to any of the preceding examples, wherein after initiation of a specific predetermined heating profile, the puff count is deactivated for a predetermined blank time interval, preferably wherein the predetermined blank time interval is 0 to 10 seconds, more preferably 0 to 5 seconds, most preferably 1 to 5 seconds.
Example Ex 21: A storage medium for use in an aerosol-generating device, the storage medium containing instructions for performing the method according to any one of examples 1 to 20 on the aerosol-generating device when interacting with aerosol-forming substrate.
Example Ex 22: The storage medium of example Ex 21, wherein the storage medium is a computer-readable medium.
Example Ex 23: An aerosol-generating device for generating an aerosol from an aerosol-forming substrate during a usage session, the aerosol-generating device comprising:
a heater;
a power supply arranged to supply power to the heater during the usage session;
control electronics; and
the storage medium of any of examples Ex 21 or Ex 22.
Example Ex 24: An aerosol-generating system comprising the aerosol-generating device of example Ex 23 and an aerosol-generating article, wherein the aerosol-generating article comprises the aerosol-forming substrate, wherein the aerosol-generating device is configured to receive the aerosol-generating article.
Example Ex 25: The aerosol-generating system of example Ex 24, wherein the aerosol-generating article comprises the heater.
Example Ex 26: The aerosol-generating system of example Ex 25, wherein the heater comprises a susceptor element, and the aerosol-generating device comprises an inductor, wherein the inductor is configured controllable by the control electronics to control the temperature of the susceptor element.

Features described in relation to one embodiment may equally be applied to other embodiments of the invention.

The invention will be further described, by way of example only, with reference to the accompanying drawings in which:

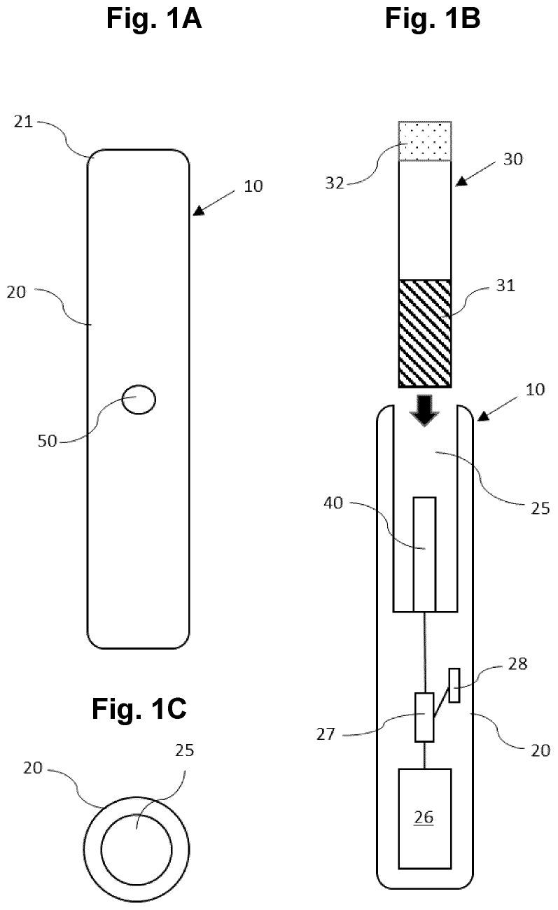

FIG. 1A shows a schematic side view of an aerosol-generating device, FIG. 1B shows a schematic cross-sectional view of a system comprising the aerosol-generating device and an article, and FIG. 1C shows a schematic top view of the aerosol-generating article;

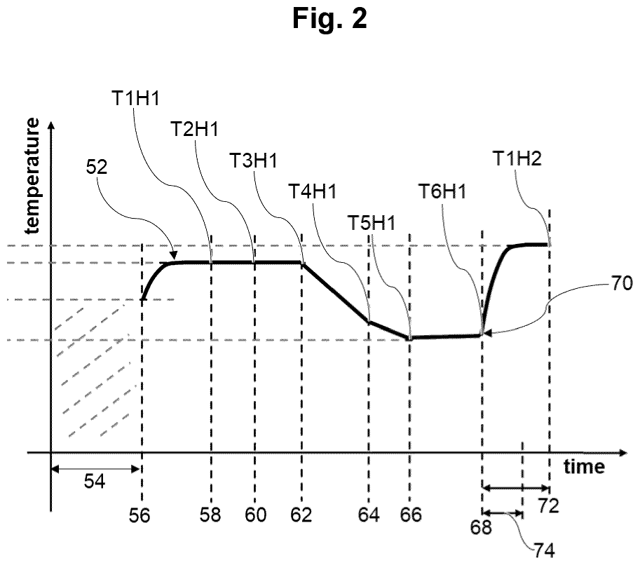

FIG. 2 shows the curve of target operating temperatures of a heater operated with the method of the present invention.

FIG. 1A shows an exemplary aerosol-generating device 10 which can be operated with the method of the present invention. However, the method of the present invention is not limited to the features of aerosol-generating device 10. The method of the present invention can be operated with all other kinds of aerosol-generating devices.

The aerosol-generating device 10 is a hand-held aerosol generating device, and has an elongate shape defined by a housing 20 that is substantially circularly cylindrical in form. The aerosol-generating device 10 comprises an open cavity 25 located at a proximal end 21 of the housing 20 for receiving an aerosol-generating article 30 comprising an aerosol-forming substrate 31. FIG. 1B shows an aerosol-generating system comprising the aerosol-generating device and the aerosol-generating article 30. The aerosol-generating device 10 has a battery 26, control electronics 27 and a storage medium 28 located within the housing 20. The storage medium 28 is readable and writable in use. An electrically-operated heater 40 is arranged within the aerosol-generating device 10 to heat at least an aerosol-forming substrate portion 31 of an aerosol-generating article 30 when the aerosol-generating article is received in the cavity 25. The storage medium 28 stores a thermal profile accessible to the control electronics 27 during use of the aerosol-generating device 10. The thermal profile defines how a target operating temperature for the heater 40 varies in a usage session.

The aerosol-generating device is configured to receive a consumable aerosol-generating article 30. FIG. 1C shows the aerosol-generating article 30 which is in the form of a cylindrical rod and comprises an aerosol-forming substrate 31. The aerosol-forming substrate 31 is a solid aerosol-forming substrate comprising tobacco. The aerosol-generating article 30 further comprises a mouthpiece such as a filter 32 arranged in coaxial alignment with the aerosol-forming substrate 31 within the cylindrical rod. The aerosol-generating article 30 has a diameter substantially equal to the diameter of the cavity 25 of the aerosol-generating device 10 and a length longer than a depth of the cavity 25, such that when the article 30 is received in the cavity 25 of the aerosol-generating device 10, the mouthpiece 32 extends out of the cavity 25 and may be drawn on by a user, similarly to a conventional cigarette.

In use, a user inserts the article 30 into the cavity 25 of the aerosol-generating device 10 and turns on the aerosol-generating device 10 by pressing a user button 50 to activate the heater 40 to start a usage session. The heater 40 heats the aerosol-forming substrate 31 of the article 30 such that volatile compounds of the aerosol-forming substrate are released and atomized to form an aerosol. The user draws on the mouthpiece of the article 30 and inhales the aerosol generated from the heated aerosol-forming substrate 31.

The aerosol-generating device 10 comprises a puff sensor (not shown) configured to detect a puff by a user on the article 30. The puff sensor is connected to the control electronics 27. The control electronics 27 are configured to set a puff count in dependence of the detected puffs. The values of the puff count can be integers including 0. The control electronics 27 are configured to increase the puff count when a puff is detected. At the beginning of a usage session the puff count is set to 0.

FIG. 2 shows the curve 52 of the target operating temperature in degree Celsius of the heater 40 in dependence of the time in seconds during a usage session. The heater 40 is operated with the method of the present invention.

Table 1 shows an example of a plurality of predetermined different heating profiles which can be used in the method of the present invention. These predetermined heating profiles can be stored in the storage medium 28 of the aerosol-generating device 10. The present invention is not limited to the number and content of the predetermined heating profiles of Table 1. The minimum are two heating profiles each comprising two target operating temperatures.

The plurality of predetermined heating profiles of Table 1 comprises 14 different heating profiles H1 to H14 (see second to last column of below Table 1). Each heating profile comprises seven target operating temperatures which are associated to seven predetermined time intervals T1 to T7, respectively (see first column of below Table 1). The first time interval T1 is 10 seconds, the second 15 seconds, the third 20 seconds, the fourth 30 seconds, the fifth 35 seconds, the sixth 50 seconds and the seventh 60 seconds. Each time interval is the time elapsed from the initiation of the specific heating profile. The specific heating temperatures T1H1 to T7H14 are reached at the end of the specific time interval. For example, temperature T4H3, i.e., 198° C., is reached after 20 seconds from the initiation of heating profile H3.

Each heating profile is associated to a respective value of the puff count. For the sake of clarity, the values of the puff count are provided with a ‘C’ before the value if the puff count (see puff count C0 to C13 in below Table 1). For example, heating profile H1 is performed when the puff count is set to C0 and heating profile H5 is performed when the puff count is set to C4. In general, heating profile Hn is performed when the puff count is set to Cn−1.

TABLE 1
Plurality of different heating profiles

| Time (s)/ | Heating profiles | | | | | | | | | | | | | |
|---|---|---|---|---|---|---|---|---|---|---|---|---|---|---|
| Temperature | H1 | H2 | H3 | H4 | H5 | H6 | H7 | H8 | H9 | H10 | H11 | H12 | H13 | H14 |
| (° C.) evolution | Puff count | | | | | | | | | | | | | |
| prior puff | C0 | C1 | C2 | C3 | C4 | C5 | C6 | C7 | C8 | C9 | C10 | C11 | C12 | C13 |
| T1: 10 | 235 | 240 | 225 | 210 | 203 | 204 | 210 | 213 | 220 | 223 | 230 | 235 | 245 | 250 |
| T2: 15 | 235 | 240 | 218 | 203 | 197 | 198 | 204 | 207 | 212 | 215 | 222 | 229 | 239 | 244 |
| T3: 20 | 235 | 240 | 211 | 196 | 191 | 192 | 198 | 201 | 210 | 213 | 220 | 227 | 237 | 242 |
| T4: 30 | 222 | 227 | 198 | 182 | 188 | 189 | 195 | 198 | 210 | 213 | 220 | 227 | 237 | 242 |
| T5: 35 | 216 | 221 | 192 | 180 | 187 | 188 | 194 | 197 | 210 | 213 | 220 | 227 | 237 | 242 |
| T6: 50 | 217 | 222 | 194 | 183 | 196 | 197 | 203 | 207 | 216 | 221 | 228 | 227 | 237 | 242 |
| T7: 60 | 218 | 223 | 197 | 186 | 203 | 204 | 210 | 213 | 220 | 221 | 228 | 227 | 237 | 242 |

The method of the present invention will be described by an exemplary usage session during which the heating profiles of Table 1 are performed. However, the invention is not limited to the specific values of Table 1. The usage session starts with activation of the aerosol-generating device 10. Upon activation a predetermined pre-heating 54 can be started (curve is not shown in FIG. 2). The pre-heating comprises a predetermined pre-heating target temperature and a predetermined pre-heating time. For example, the pre-heating target temperature can be 235° C. and the pre-heating time 28 seconds. The pre-heating temperature is targeted as fast as possible by providing maximum power from the battery 26 to the heater 40. The reaching of a specific intermediate temperature, for example 140° C., can be indicated to the user by haptic feedback. Such haptic feedback can be, for example, a vibration of the aerosol-generating device. The end of the pre-heating can be indicated by another haptic feedback. When the pre-heating target temperature is reached, this temperature is maintained as a plateau until the pre-heating time has elapsed. During this pre-heating the puff count is deactivated. This means that detection of a puff by the puff sensor will not increase the puff count.

After the pre-heating time (dashed line 56), the control electronics will directly start with the first heating profile H1 of Table 1. During the pre-heating the puff count is set to C0, because during the pre-heating time the puff count cannot be increased and the puff count is set to C0 at the beginning of a usage session. Therefore, the first heating profile H1 is initiated at puff count C0. Directly after the pre-heating, the puff count will be activated by the control electronics 27. If no puff is detected heating profile H1 will run as follows:

Initiating heating profile H1 leads to the control of the supply of power to the power supply in order to adjust a temperature of the heater to the first target temperature of heating profile T1H1, i.e., 235° C. The heater 40 is powered with the maximum power allowed to reach the first target temperature as fast as possible. This temperature is kept for 10 seconds (time interval between dashed lines 56 and 58). Target operating temperature T2H1, i.e., 235° C., is kept for further 5 seconds (time interval between dashed lines 58 and 60). Target operating temperature T3H1, i.e., 235° C., is kept for further 5 seconds (time interval between dashed lines 60 and 62). Therefore, the heater 40 is kept at 235° C. in total for 20 seconds.

After 20 seconds from initiation of heating profile H1, the heater 40 is cooled to target operating temperature T4H1, i.e., 222° C. This target operating temperature is reached in a linear decrease during 10 seconds (time interval between dashed lines 62 and 64) which is 30 seconds from initiation of heating profile H1.

After 30 seconds from initiation of heating profile H1 the heater 40 is further decreased to target operating temperature T5H1, i.e., 216° C. This target operating temperature is reached within 5 seconds (time interval between dashed lines 64 and 66).

The subsequent target operating temperature T6H1, i.e., 217° C., is reached within further 15 seconds (time interval between dashed lines 66 and 68).

All heating profiles H1 to H14 of Table 1 take 60 seconds if no puff is detected. However, the present invention is not limited to heating profiles with this specific time duration or to all heating profiles having the same time duration. After 60 seconds of initiating a specific heating profile, the subsequent heating profile is initiated. Therefore, if no puff is detected during the 60 seconds of the heating profile H1, subsequent heating profile H2 is initiated. This leads to the heating of the heater 40 to the specific seven target operating temperatures T1H2 to T2H2 of heating profile H2 in the same manner as described for heating profile H1.

Alternatively, if a puff is detected during heating profile H1, the subsequent heating profile H2 is directly initiated. For example, if after 50 seconds from initiation the heating profile H1, a puff 70 is detected, the subsequent heating profile H2 will be initiated. Therefore, in the example shown in FIG. 2, after target operating temperature T6H1, the heater 40 is heated to target operating temperature T1H2, i.e., 240° C. within 10 seconds (time interval between dashed line 68 and 72). Heating profile H2 runs then in the same manner as described for heating profile H1, until a puff is detected, or until 60 seconds have elapsed. In both cases the subsequent heating profile H3 will then be initiated. The heating profiles H1 to H14 are initiated sequentially one after the other. Each heating profile can either completely run from the first target operating temperature T1Hn to the last target operating temperature T7Hn within 60 seconds, or can be interrupted in case of a detected puff.

Heating profiles H2 to H14 all have a blank time 74 of, for example, 5 seconds, in the beginning of each heating profile. During this blank time, the puff count is deactivated. Thereby a detected puff is ignored.

When the last heating profile H14 is finished the control electronics 27 will re-loop heating profile H14 until the maximum time of the usage session has elapsed. Such a maximum usage session may for example be 550 seconds.

Below Table 2 shows an alternative example of a plurality of predetermined different heating profiles. These predetermined heating profiles can be stored in the same storage medium 28 of the aerosol-generating device 10 or in a different aerosol-generating device. The plurality of predetermined different heating profiles of Table 2 comprises 11 different heating profiles H1 to H11. Each heating profile comprises also seven target operating temperatures which are also associated to seven predetermined time intervals (see first column of below Table 2), respectively. Therefore, the heating profiles of Table 2 below differ from Table 1 above in the amount of heating profiles and the corresponding temperatures, but the other characteristics described above are the same. When the last heating profile H11 is finished the control electronics 27 will re-loop heating profile H11 until the maximum time of the usage session has elapsed. The maximum usage session of the plurality of predetermined different heating profiles of Table 2 may for example be 430 seconds.

TABLE 2
Plurality of different heating profiles

| Time (s)/ | Heating profiles | | | | | | | | | | |
|---|---|---|---|---|---|---|---|---|---|---|---|
| Temperature | H1 | H2 | H3 | H4 | H5 | H6 | H7 | H8 | H9 | H10 | H11 |
| (° C.) evolution | Puff count | | | | | | | | | | |
| prior puff | C0 | C1 | C2 | C3 | C4 | C5 | C6 | C7 | C8 | C9 | C10 |
| T1: 10 | 235 | 245 | 240 | 213 | 208 | 209 | 215 | 223 | 230 | 233 | 245 |
| T2: 15 | 235 | 250 | 234 | 206 | 202 | 203 | 209 | 217 | 222 | 225 | 237 |
| T3: 20 | 235 | 250 | 229 | 200 | 196 | 197 | 203 | 211 | 220 | 223 | 235 |
| T4: 30 | 222 | 232 | 204 | 182 | 192 | 193 | 199 | 203 | 220 | 228 | 240 |
| T5: 35 | 216 | 221 | 192 | 180 | 190 | 195 | 201 | 207 | 220 | 235 | 245 |
| T6: 50 | 217 | 221 | 192 | 199 | 207 | 212 | 219 | 226 | 233 | 245 | 250 |
| T7: 60 | 218 | 221 | 192 | 212 | 217 | 223 | 231 | 238 | 241 | 250 | 250 |

The heating profiles of Tables 1 and 2 comprise a variety of different heating profiles. For example, heating profiles H1 and H2 of Table 1 both start with a temperature plateau, followed by a temperature decrease which is followed by a temperature increase. Heating profile H3 starts with a temperature decrease which is followed by a temperature increase. Heating profile H11 starts with a temperature decrease followed by a temperature plateau, which is followed by a temperature increase. Heating profile H13 starts with a temperature decrease which is followed by a temperature plateau. But not only a temperature decrease or plateau is possible in a first stage of the heating profiles, heating profile H2, for example, starts with a temperature increase, which is followed by a temperature plateau, followed by a temperature decrease and another temperature plateau.

Below Table 3 shows another alternative example of a plurality of predetermined different heating profiles. These predetermined heating profiles can be stored in the same storage medium 28 of the aerosol-generating device 10 or in a different aerosol-generating device. The plurality of predetermined different heating profiles of Table 3 comprises 12 different heating profiles H1 to H12. Each heating profile comprises also seven target operating temperatures which are also associated to seven predetermined time intervals (see first column of below Table 3), respectively. Therefore, the heating profiles of Table 3 below differ from Table 1 above in the amount of heating profiles and the corresponding temperatures, but the other characteristics described above are the same. When the last heating profile H12 is finished the control electronics 27 will re-loop heating profile H12 until the maximum time of the usage session has elapsed. The maximum usage session of the plurality of predetermined different heating profiles of Table 3 may for example be 485 seconds.

TABLE 3
Plurality of different heating profiles

| Time (s)/ | Heating profiles | | | | | | | | | | | |
|---|---|---|---|---|---|---|---|---|---|---|---|---|
| Temperature | H1 | H2 | H3 | H4 | H5 | H6 | H7 | H8 | H9 | H10 | H11 | H12 |
| (° C.) evolution | Puff count | | | | | | | | | | | |
| prior puff | C0 | C1 | C2 | C3 | C4 | C5 | C6 | C7 | C8 | C9 | C10 | C11 |
| T1: 10 | 235 | 250 | 249 | 228 | 208 | 209 | 215 | 220 | 228 | 231 | 241 | 241 |
| T2: 15 | 235 | 255 | 244 | 222 | 202 | 203 | 207 | 214 | 218 | 223 | 233 | 233 |
| T3: 20 | 235 | 255 | 239 | 217 | 196 | 197 | 200 | 208 | 216 | 221 | 231 | 231 |
| T4: 30 | 222 | 232 | 210 | 185 | 202 | 203 | 206 | 214 | 225 | 235 | 242 | 242 |
| T5: 35 | 216 | 218 | 190 | 180 | 205 | 207 | 209 | 217 | 228 | 238 | 244 | 244 |
| T6: 50 | 217 | 216 | 188 | 197 | 209 | 215 | 220 | 228 | 231 | 241 | 250 | 250 |
| T7: 60 | 218 | 216 | 188 | 204 | 214 | 220 | 225 | 233 | 241 | 250 | 250 | 250 |

1.-15. (canceled)

16. A method of operating an aerosol-generating device for generating an aerosol from an aerosol-forming substrate during a usage session,
the aerosol-generating device comprising a heater, a power supply arranged to supply power to the heater during the usage session, and control electronics; and
the method comprising using the control electronics of the aerosol-generating device to:
initiate one of a plurality of predetermined different heating profiles for the heater, wherein each heating profile comprises a plurality of different target operating temperatures for the heater, wherein one heating profile comprises a temperature increase of subsequent target operating temperatures and another one heating profile comprises a temperature decrease of subsequent target operating temperatures, and
control a supply of power from the power supply in order to adjust a temperature of the heater to a target operating temperature of the plurality of target operating temperatures,
wherein each of the plurality of target operating temperatures comprises between 4 different target operating temperatures and 7 different target operating temperatures, and
wherein the temperature of the heater increases or decreases linearly from one target operating temperature to a next target operating temperature.

17. The method according to claim 16, wherein the plurality of heating profiles comprises a first heating profile comprising a temperature increase of subsequent target operating temperatures and a temperature decrease of subsequent target operating temperatures.

18. The method according to claim 16,
wherein the plurality of heating profiles comprises a first heating profile comprising a temperature increase of subsequent target operating temperatures, a temperature decrease of subsequent target operating temperatures, and a temperature plateau of subsequent target operating temperatures, and
wherein the plurality of heating profiles comprises a second heating profile and a third heating profile each comprising a temperature increase of subsequent target operating temperatures, a temperature decrease of subsequent target operating temperatures, and a temperature plateau of subsequent target operating temperatures.

19. The method according to claim 16, wherein each of the plurality of different target operating temperatures for the heater is associated to a plurality of different predetermined time intervals, respectively.

20. The method according to claim 16,
wherein the plurality of different target operating temperatures comprises a first, a second, and a third target operating temperature, and
wherein the first target operating temperature is associated to a first predetermined time interval, the second target operating temperature is associated to a second predetermined time interval, and the third target operating temperature is associated to a third predetermined time interval.

21. The method according to claim 16,
wherein the plurality of different target operating temperatures comprises a first, a second, and a third target operating temperature,
wherein the first target operating temperature is associated to a first predetermined time interval, the second target operating temperature is associated to a second predetermined time interval, and the third target operating temperature is associated to a third predetermined time interval,
wherein the plurality of different target operating temperatures further comprises a fourth, a fifth, and a sixth target operating temperature, and
wherein the fourth target operating temperature is associated to a fourth predetermined time interval, the fifth target operating temperature is associated to a fifth predetermined time interval, and the sixth target operating temperature is associated to a sixth predetermined time interval.

22. The method according to claim 16, wherein the plurality of predetermined heating profiles is between 5 different predetermined heating profiles to 20 different predetermined heating profiles.

23. The method according to claim 16, wherein the aerosol-generating device further comprises a puff sensor configured to detect a puff by a user on the aerosol-generating device.

24. The method according to claim 23, wherein each of the plurality of heating profiles is initiated in dependence on a puff count of an applied puff in the usage session.

25. The method according to claim 24, wherein detection of a puff increases the puff count.

26. The method according to claim 25,
wherein one or both of the plurality of predetermined heating profiles is initiated sequentially one after the other in dependence of the puff count,
wherein when no puff is detected during a heating profile, the puff count is increased,
wherein when the puff count is increased, the next of the plurality of predetermined heating profiles is initiated,
wherein each of the plurality of predetermined heating profiles is associated to a respective value of the puff count,
wherein values of the puff count can be integers including 0,
wherein the integer 0 is set before a puff is detected, and
wherein the puff count is 1 when a first puff is detected.

27. The method according to claim 25,
further comprising performing a preheating after a manual activation by a user,
wherein the preheating comprises heating the heater to a predetermined preheating target temperature during a predetermined preheating time, and
wherein during this preheating time the puff count is deactivated.

28. The method according to claim 27, wherein the preheating time is 20 seconds to 60 seconds.

29. The method according to claim 27,
wherein a first predetermined heating profile of the plurality of predetermined heating profiles is initiated after the elapse of the preheating time, and
wherein a value 0 of the puff count is associated to the first predetermined heating profile.

30. The method according to claim 29, wherein each of the plurality of predetermined heating profiles is associated to a respective value of the puff count.

31. The method according to claim 16, wherein after initiation of a specific predetermined heating profile, the puff count is deactivated for a predetermined blank time interval.

32. A nontransitory computer-readable storage medium for use in an aerosol-generating device, the storage medium containing instructions, which when executed by the control electronics of the aerosol-generating device, cause the control electronics to perform the steps of the method according to claim 16 on the aerosol-generating device when interacting with aerosol-forming substrate.

33. An aerosol-generating device for generating an aerosol from an aerosol-forming substrate during a usage session, the aerosol-generating device comprising:
a heater;
a power supply arranged to supply power to the heater during the usage session;
control electronics; and
the nontransitory computer-readable storage medium according to claim 32.

34. An aerosol-generating system comprising the aerosol-generating device according to claim 33 and an aerosol-generating article, wherein the aerosol-generating article comprises the aerosol-forming substrate, and the aerosol-generating device is configured to receive the aerosol-generating article.

35. The aerosol-generating system according to claim 34,
wherein the aerosol-generating article comprises the heater,
wherein the heater comprises a susceptor element and the aerosol-generating device comprises an inductor, and
wherein the inductor is configured to be controllable by the control electronics to control a temperature of the susceptor element.
